(19) United States
(12) Patent Application Publication
(10) Pub. No.: US 2014/0242422 A1
(43) Pub. Date: Aug. 28, 2014

(54) LI-ION BATTERY MONITOR

(71) Applicants: Eva Hakansson, Wheat Ridge, CO (US); William Dube, Wheat Ridge, CO (US)

(72) Inventors: Eva Hakansson, Wheat Ridge, CO (US); William Dube, Wheat Ridge, CO (US)

(21) Appl. No.: 14/141,815

(22) Filed: Dec. 27, 2013

Related U.S. Application Data
(63) Continuation of application No. 13/851,823, filed on Mar. 27, 2013.
(60) Provisional application No. 61/770,245, filed on Feb. 27, 2013.

(51) Int. Cl. H01M 10/48; H01M 2/34

(52) U.S. Cl. CPC H01M 10/48; H01M 2/34
USPC 429/50; 429/90; 429/61; 429/53

(57) ABSTRACT

A Li-Ion monitor includes a combustible vapor sensor positioned in air flow communication with the exterior of a hermetically sealed Li-Ion battery cell to detect combustible vapor escaping therefrom. Detection of the vapor indicates that an overheat or fire situation may be impending. Where the Li-Ion battery cell is immersed in liquid, the combustible vapor sensor is in air flow communication with a surface of the liquid. Alternatively, or additionally, an electrolyte sensor can be immersed in or otherwise in fluid flow communication with the liquid to detect electrolyte escaping from the cell which electrolyte would, if exposed to air, become a combustible vapor.

### RELATED APPLICATIONS

This application is a continuation of our U.S. application Ser. No. 13/851,823 filed Mar. 27, 2013 and claims the benefit of our Provisional U.S. Application No. 61/770,245, filed Feb. 27, 2013, the disclosures of both of which are incorporated herein by reference in their respective entireties.

### TECHNICAL FIELD

The present invention relates generally to lithium-ion (“Li-Ion”) and similar batteries, and more specifically, to systems and methods for monitoring such batteries.

### BACKGROUND

Li-Ion batteries are in widespread use. Some examples are portable devices such as cell phones, laptops, and pads, and transportation systems such as electric cars and some jet liners. Typical Li-Ion batteries are comprised of one or more hermetically sealed cells electrically coupled to provide the desired voltage and current capabilities of the battery. Within the hermetically sealed cells is the chemistry necessary to generate the electrical output from the cells. The hermetic seal is important as it avoids exposure of the cell chemistry to the environment.

A disturbing trend has been found with the use of Li-Ion batteries. In particular, Li-Ion batteries have been reported to unexpectedly overheat or catch fire, creating risks of serious damage or injury. For example, portable devices have overheated or caught fire presenting risk of injury to their users. And transportation systems have been faced with similar concerns, but with potentially even greater risk of injury or devastation. A transportation system, such as a vehicle, might be rendered inoperable, which is not only inconvenient, it can have serious consequences if the fire occurs while the vehicle is occupied or otherwise in use. And in the case of jet liners, the consequences are almost unimaginable. Indeed, Boeing's fleet of Dreamliner® jets was grounded due to fires and the like from the battery systems.

Conventional efforts to monitor Li-Ion batteries have not proven themselves entirely sufficient for the task. Indeed, such efforts are based on detection of actual failure but that is often too late.

### SUMMARY OF THE INVENTION

We have developed a system and method to monitor Li-Ion and similar batteries in such a way as to anticipate the potential onset of overheating or fire so that steps may be taken to avert or at least minimize the problem before the battery overheats or catches fire. In particular, we have determined that the chemistry inside the Li-Ion cells generates a combustible vapor if leaked from the interior to the exterior of the cell into contact with the air outside of the cell, such as due to failure of the seal, impending failure of the cell, or rupture of the cell, and which can be detected before undue overheating occurs or a fire breaks out. The likelihood that any breach of the cell will generate the combustible vapors is considered to be particularly significant if the cell is in operation, such as when current flows through the cell, which occurs when it is coupled to a charging device to provide power to the cell and/or when it is coupled to a power a device such that power is being drawn from the cell. To that end, and in accordance with the principles of the present invention, a combustible vapor sensor is positioned outside of the cell(s) in air flow communication with the exterior of the hermetically sealed battery cell(s). If the sensor detects combustible vapors from the cell(s), a signal can be given to generate an alert and/or cause a corrective action to be taken before the situation gets out of hand. Such alerts or corrective action can be considered a response actuated by detection of the combustible vapor exiting from the cell. As a consequence, sensing for the presence of combustible vapors in the vicinity of the normally sealed cells can provide advance warning of an impending failure or worse, and allow for steps to be taken to avert of minimize the problem.

The sensor signal can be used to initiate a response in the form of a human-perceptible alert, such as one or more visual signals such as lights, displays, or illuminated lettering, audible signals such as bells, tones, or horns, and haptic indicators, or other similar devices. The alert can then be utilized by those in the vicinity to make a decision as to what, if anything to do. In some cases, such as where the Li-Ion battery is being used for short term purposes, such as in an electric dragster vehicle, depending on the level of vapor being detected (which may be indicated by a number on a display, or the hue or number of lit alert lamps, for example), the driver or crew can make the decision to proceed with the race or shut down the vehicle. In other situations, the system can be shut down manually, or automatically. For example, if an alert is given in a vehicle, the driver can pull off of the road, and the occupants can at least get away from the vehicle if not also turn off the vehicle. Where the Li-Ion battery is in a portable device, the alert can be used to warn the user to stay away from the device, to disconnect the device from the charger, and/or to remove the battery, if possible.

Advantageously, the sensor signal can also be used to generate a response which automatically takes corrective action such as by disrupting, either wholly or partially, current through the cell(s). In that regard, it is considered likely that reducing the electrical power to and/or from the Li-Ion battery may also reduce the likelihood that the battery will overheat or lead to a fire situation. For example, the signal can be used to open the circuit between the cell and a charging circuit and/or between the cell and the device being powered thereby, such as by blowing or opening one or more breakers or fuses, or causing one or more power coupling relays to be in an open state, thus completely disrupting current flow.

By way of further example, where the Li-Ion battery has a battery management system, the state of the system can be forced to change from the normal operating state to a second, reduced operating state where current flow is either partially disrupted, such as by current limiting, or fully disrupted. Thus, in the reduced operating state, the power to or from the battery or cell(s) may be limited, one or more of the cells could be electrically disconnected, or the battery could be shut down, such as by disconnecting one or both of its terminals from any operating devices, such as chargers and/or powered devices. As a still further example, where the chemistry of the battery cell(s) is not incompatible with fire suppression, a fire suppression system could additionally or alternatively be activated to quench a fire situation before it erupts or gets out of hand.

In many Li-Ion batteries, the cells are contained within a compartment or housing (both being referred to herein as a housing for sake of convenience), and the housing can be open or vented to atmosphere. In accordance with the principles of the present invention, the sensor can be situated in an air path communicating with the interior of the housing, such as within the housing, on an exterior wall of the housing such as near the housing opening or vent, or in communication with a portal of the housing. The sensor is thus also in air flow communication with the exterior of the hermetically sealed battery cell(s).

There are some situations where the Li-Ion battery cells are contained with a housing filled with a liquid medium, such as a non-conductive coolant or a liquid-gas mixture, rather than in air. In accordance with the principles of the present invention as described above, the chemistry leaking from the cell(s) can be detected as a combustible vapor once it also escapes from the liquid, such as with a combustible vapor sensor in air flow communication with the surface of the liquid. Alternatively, we have determined that the chemistry in the cell includes an electrolyte which, when exposed to air becomes a combustible vapor, but which can be detected in the liquid in its electrolyte form such as by an electrolyte sensor in fluid flow communication with the liquid, before or even without the electrolyte going into the combustible vapor state. To that end, and in accordance with a further aspect of the present invention, we place an electrolyte sensor outside of the cell(s) in fluid flow communication with the exterior of the hermetically sealed battery cell(s), such as immersed in or otherwise in fluid communication with the liquid. If the electrolyte sensor detects the electrolyte from the cell(s), a signal can be given to either generate an alert and/or cause a corrective action to be taken before the situation reaches the stage of overheating and/or a fire breaks out, as in the case of the detection of combustible vapors.

Without limiting ourselves to any scientific theory or principle, we have determined that it is the combustible vapors which might leak from the cell(s) that might actually fuel and lead to the overheating and fire situations. In particular, the highly energetic nature of the internal chemistry of a Li-Ion cell is such that if the cell is breached, the chemistry may become a self-sustaining fuel source for overheating and fires. Similarly, we have determined that failure of a Li-Ion battery is often associated with breaching of the hermetic seal environment of the cell, which in turn can lead to the overheating or fire situations. Based thereon, we have determined that sensing for the presence of combustible vapors in air in the vicinity of the normally sealed cells, and/or for the presence of the Li-Ion cell electrolyte in liquid in the vicinity of the normally sealed cells, can provide advance warning of an impending failure or worse, and allow for steps to be taken to avert of minimize the problem.

By virtue of the foregoing, there is provided a system and method to monitor Li-Ion and similar batteries in such a way as to anticipate the potential onset of overheating or fire so that steps may be taken to avert or minimize the problem before the battery overheats or catches fire. These and other advantages of the present invention will become apparent from the following brief and detailed descriptions of the drawings.

### BRIEF DESCRIPTION OF THE DRAWINGS

The accompanying drawings, which are incorporated in and constitute a part of this specification illustrate embodiments of the invention and, together with the general description given above and the detailed description given below, serve to explain the principles of the present invention.

FIG. 1 is a perspective, partially cut-away view of a hermetically sealed Li-Ion battery cell and a combustible vapor sensor in air flow communication with the exterior of the cell in accordance with the principles of the present invention;

FIG. 2 is a schematic drawing of the cell and sensor of FIG. 1 in combination with a powered device and charger device for purposes of explaining the principles of the present invention;

FIG. 3 is a view similar to FIG. 2 for purposes of explaining operation thereof in actuating a human-perceptible alert as the actuatable response;

FIGS. 4A and 4B are views similar to FIG. 2 for purposes of explaining operation thereof in actuating an automatic corrective action as the actuatable response

FIGS. 5A and 5B are views of the cell of FIG. 1 in a housing, and the sensor of FIG. 1 in (FIG. 5A) or outside of (FIG. 5B) the housing, for further explaining the principles of the present invention;

FIG. 6 is a perspective view of multiple cells and combustible vapor sensors in air flow communication with the exterior of the respective cells in accordance with the principles of the present invention;

FIG. 7 is a schematic view of the cells and sensors of FIG. 6 for purposes of explaining operation of responses in accordance with the principles of the present invention;

FIG. 8 is a schematic of a control circuit which can be used with the sensor of FIG. 1; and

FIG. 9 is a perspective view of the cell of FIG. 1 immersed in liquid in a housing for further explaining the principles of the present invention.

### DETAILED DESCRIPTION OF THE DRAWINGS

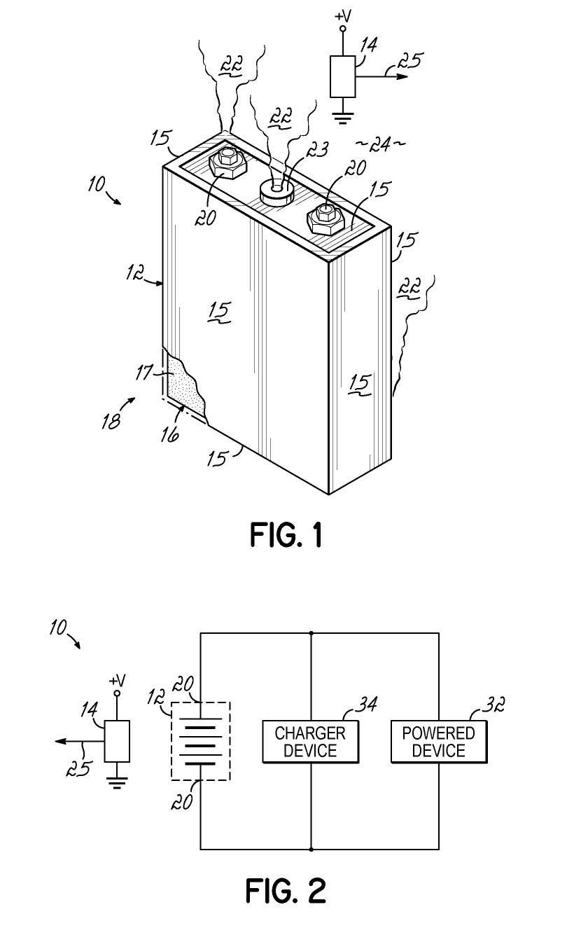

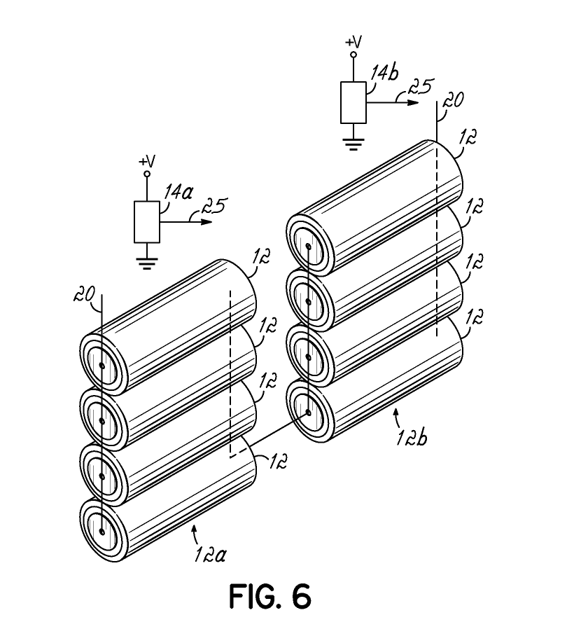

With reference to FIG. 1 there is shown an exemplary embodiment of a Li-Ion battery monitor 10 in accordance with principles of the present invention. Monitor 10 includes at least one hermetically sealed Li-Ion battery cell 12 and a combustible vapor sensor 14. The cell 12 has a plurality of walls 15 defining a shape, such as prismatic as shown in this embodiment or cylindrical (see, e.g., FIG. 6), within which is an interior 16 of the cell 12 containing the chemistry 17 thereof and sealed off from the exterior 18 of the cell 12. The cell 12 also has a pair of terminals 20 electrically coupled to the interior 16. The chemistry 17 within the interior 16 is adapted to generate voltage across and/or current through the terminals 20 accessible at the exterior 18 of the cell 12. The sensor 14 is positioned in air flow communication with the exterior 18 of the cell 12 so as to detect combustible vapors 22 which may escape from the cell 12, such as from a normally sealed vent 23 thereof, or through one or more of the walls 15 thereof, such as due to fractures or other damage to the wall(s) 15.

The sensor 14 may be powered by the cell 12, or may have a separate source of power, such as C-MOS batteries, a regulator or power supply, or the like (not shown). Should the cell 12 be headed to a failure that could result in overheating or fire, the chemistry 17 in the interior 16 of the cell 12 may produce a combustible vapor 22 should it leak or otherwise migrate from the cell interior 16 to the exterior 18 thereof and come into contact with the air 24 (such as ambient air or other gas) thereabout. The sensor 14 is positioned in air flow communication with the air 24, and thus with the exterior 18 of the cell 12 so as to be able to detect the presence of the combustible vapor 22 from the cell 12. As will be readily appreciated, the sensor 14 may be affixed to a wall 15 of the cell 12, or may be held in spaced relation thereto, in order to be in air flow communication with the exterior 18 of the cell 12.

Advantageously, the sensor 14 is adapted to generate a signal 25 indicative of the detection of the combustible vapor 22 from the cell 12. The signal 25 may be used in any number of ways to actuate a response 30 as will be described below. By way of example, and with reference to FIG. 2, the terminals 20 of the cell 12 are electrically coupled to a powered device 32. The powered device 32 could be any electrically powered device, examples of which are portable devices and transportation systems, to name a few. With the cell 12 electrically connected to power the device 32, current will flow through the cell 12 as power is generated by the chemistry 17 and coupled to the device 32. The terminals 20 may also be coupled to a charger device 34 to provide power to the cell 12, such as to recharge same, which also causes current to flow through the cell 12. During operation of the cell 12, either during charging such that power is delivered to the cell 12 from the charger device 34 or in discharging and delivering power to the powered device 32, should the chemistry 17 somehow exit to the exterior 18 of the cell 12 and become exposed to the air 24, combustible vapors 22 are expected to be generated. Detection of vapors 22 by the sensor 14 results in the signal 25 indicative thereof. The signal 25 is available for any number of purposes, several of which are described hereinbelow.

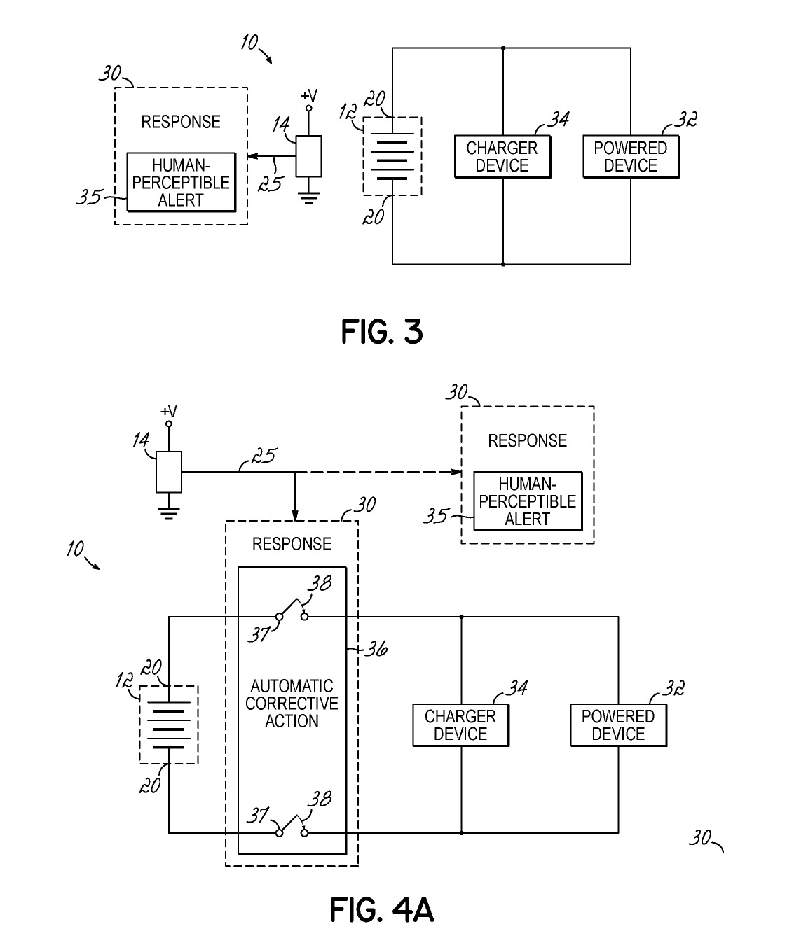

With reference to FIG. 3, the signal 25 may be used to actuate a response 30 in the form of a human-perceptible alert 35, such as visually perceptible lights, displays, and illuminated devices, audibly perceptible horns, bells, and other sounding devices, and/or haptic or tactile indicators. In one example, the alert 35 could be one or more lights to provide an indication to others viewing the lights of an impending failure of the cell 12. There could be just one light which is either off when the vapors 22 are not detected or on when they are detected. Alternatively, the light could have different hues, or there could be multiple lights, that are selectively actuated in response to a level of vapors 22 detected as indicated by the level of signal 25. Thus, signal 25 could have two states indicating detection or lack of detection of vapors 22, or could be a multi-level signal which at one level, such as a minimum level, indicates no detection of vapors 22, at an opposite level, such as at a maximum level, indicates detection of a high level of vapors 22, and at levels therebetween, indicates a relative level of vapors 22 therebetween.

The alert 35 could, additionally or alternatively, be a display showing a warning message or displaying a number indicative of the level of vapors 22 detected by the sensor 14 in relation to the level of signal 25. The display could be in the form of a meter with a needle that moves in relation to the level of the signal 25, or a digital display which is driven by a digital representation of the level of signal 25, such as provided by an A/D converter (not shown) known in the art. In another example, the alert 35 could, additionally or alternatively, be a horn or other sounding device to give audible warning of the detection of the vapors 22 and/or a haptic indicator to provide a tactile sensation warning of the detection of the vapors 22. Anyone in the vicinity of the alert 35 who is able to hear, see, or feel same (as applicable) will then be able to make a decision as to what, if anything, to do.

If the powered device 32 is a vehicle such as an electric dragster, the use of the cell 12 may be expected for only a short period of time. The driver or crew (neither shown) can decide once they receive the alert 35, whether to proceed to race the dragster or to shut it down and/or evacuate the area. If the race proceeds, the driver will be armed with the knowledge that the dragster should be shut down and/or prompt escape from the vehicle may be necessary.

If the powered device 32 is a passenger-type of vehicle, such as a car or truck by way of example, the driver (not shown), upon receiving the alert may elect to pull off of the road, allowing the occupants (not shown), including the driver, to at least get away from the vehicle if not also turn same off. Where the powered device 32 is a jet liner, for example, the cockpit crew (not shown) may thus be aware of the need to take steps necessary to protect the passengers and equipment before a catastrophic situation erupts.

If the powered device 32 is a portable device, the alert may cause those receiving it to stay away from the device, to remove it from their person (such as off of their lap) or clothing (such as from a pocket), and/or to remove the battery, if possible.

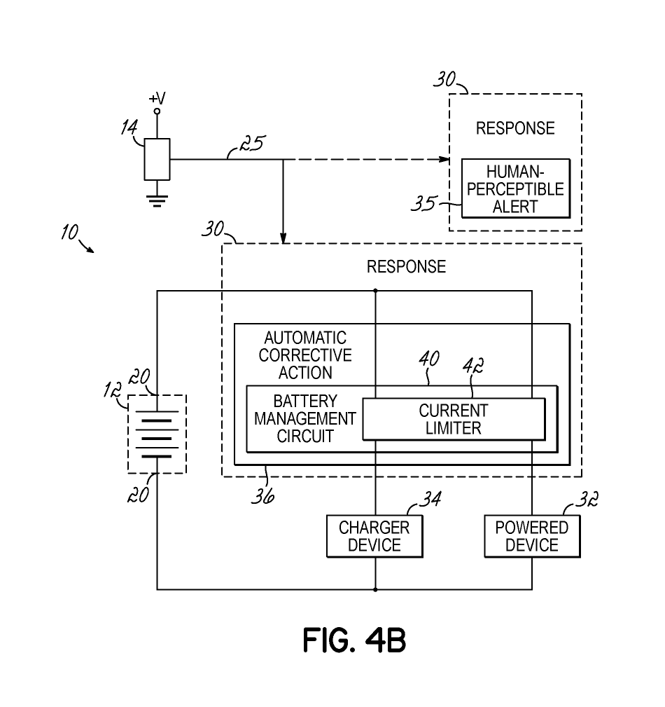

With reference to FIG. 4A, the signal 25 may be additionally or alternatively used to actuate a response 30 in the form of an automatic corrective action circuit 36 by which to take automatic corrective action such as to reduce or cut off power to or from the cell 12, thus disrupting current flow, entirely or partially, through the cell 12 in order to attempt to avert or at least minimize the risk of overheating or fire. The corrective action circuit 36 may be coupled in series between the terminals 20 of the cell 12 and either or both of the powered device 32 and/or the charger device 34. The corrective action circuit 36 may provide current limiting or define an open circuit by which to thus disrupt current flow, partially or entirely, through the cell 12. Although shown as connected to both of the terminals 20, it will be appreciated that the corrective action circuit 36 might be connected to only one of the terminals 20.

The corrective action circuit 36 may be one or more breakers, fuses, relays, or other type of switching elements 37, electrically in series between one or both of the terminals 20 of the cell 12 and the charger device 34 and/or the powered device 32. In order for current to flow through the cell 12, the corrective action circuit 36 must be in a closed or short circuit condition as exemplified by the arrows 38, but may otherwise be in an open condition, such as in an open-circuit state.

The signal 25 may be operatively coupled to the corrective action circuit 36 to control same. For example, in one embodiment, the signal 25 has a first state when the combustible vapor 22 from the cell 12 is not being detected and a second, different state when the combustible vapor 22 is being detected. In the first state, the corrective action circuit 36 is in the closed or short-circuit condition (which may be the nominal state for a breaker, fuse, or normally-closed relay, but may be the condition created in response to the signal 25 in the first state if the relay is a normally-open relay) such that current flows through the cell 12, either due to power being coupled from the charger device 34 to the cell 12 and/or to power being provided from the cell 12 to the powered device 32. When the signal 25 is in the second state, the corrective action circuit 36 is otherwise in the open condition (such as be tripping or blowing the broker or fuse, or forcing the relay to the open condition if it is a normally-closed relay or allowing it to take on its nominal condition if it is a normally-open relay). The result is to open the electrical circuit between the cell 12 and the charger device 34 and/or the powered device 32, which stops, i.e., fully disrupts, current flow through the cell 12 thereby discontinuing either charging from the charger device 34 and/or power the powered device 32 (at least from the cell 12). That disruption of current may also reduce the energetic behavior of the cell 12, and might avert or at least delay or otherwise minimize the onset of undue overheating or fire.

In some situations, a battery management circuit 40 may be included with, or may form, the corrective action circuit 36 as exemplified by reference to FIG. 4B. In one example, a battery management circuit 40 in one configuration normally allows full current flow through the cell 12. In another configuration, such as responsive to the signal 25 indicating that combustible vapors 22 have been detected by the sensor 14, the battery management circuit 40 may partially disrupt current flow by interposing a current limiter 42 in the circuit path between the cell 12 and the powered device 32 and/or the charger device 34. Such a partial disruption in the form of a current limit may avert or at least delay or otherwise minimize the onset of undue overheating or fire, while still allowing the powered device 32 to be operable, even if in a limited fashion. Advantageously, the corrective action circuit 36 will fully interrupt power from the charging device 34 and will either fully or partially interrupt power to the powered device 32, depending upon the design requirements of the powered device 32, thus disrupting, at least partially if not fully, current flow through the cell 12. In that regard, the charging device 34 could form part of the powered device 32, such as a generator or auxiliary power supply in a transportation system, or could be a separate component, such as a brick to be plugged into an AC outlet (not shown) to charge portable devices.

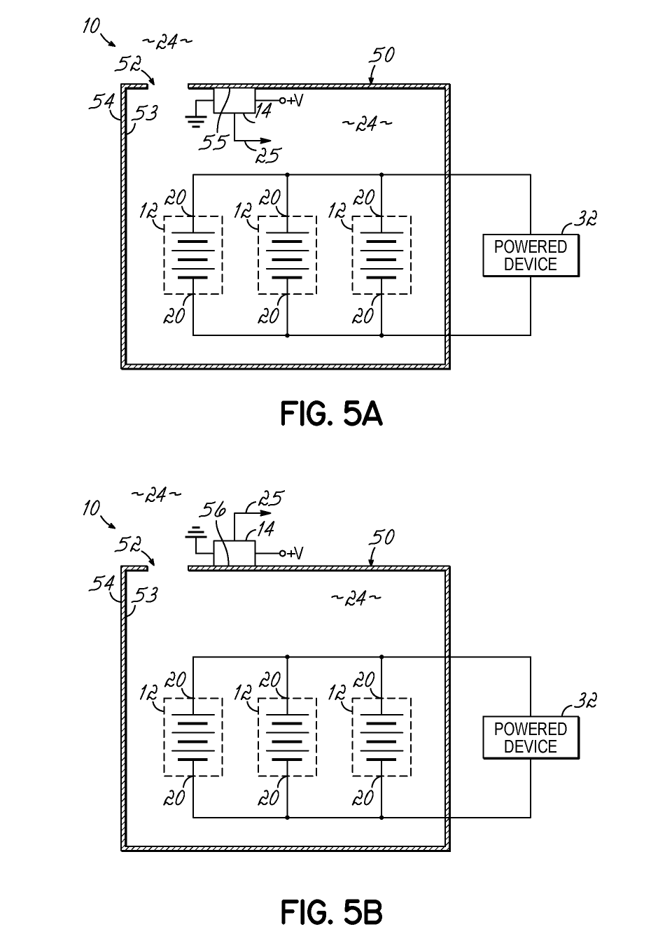

It will be appreciated that many Li-Ion batteries include several Li-Ion cells 12, each of which could be a source of failure. Where multiple cells 12 are utilized, they will typically be held within a container or housing 50 (even where just one cell 12 is involved, a housing 50 could be employed) as shown in FIGS. 5A and 5B (where cells 12 are shown electrically connected in parallel, although it will be appreciated that they could, in whole or in part, be coupled electrically in series instead as will be readily apparent). The housing 50 may have a vent 52 for air to pass between the interior 53 of the housing 50 and the environment external thereto such as outside the exterior 54 of the housing 50. The vent 52 may be small or could be defined by a large opening of the housing, one example of which is an open top through which the cells 12 can be easily removed from, and replaced into, the interior 53. The sensor 14 can be utilized to monitor for the release of the combustible vapor 22 from any or all of the cells 12 therein.

To that end, the sensor 14 is advantageously situated in an air path communicating with the interior 53 of the housing 50. The sensor 14 may be mounted in the interior 53 of the housing 50 as at 55 (FIG. 5A) to thus be positioned in air flow communication with the interior 53 and, thus, the exterior 18 of the cells 12. Alternatively, or additionally where more than one sensor 14 is to be used, the sensor 14 may be mounted to the exterior 54 of the housing 50, such as near the vent 52 as at 56 (FIG. 5B) to thus be in air flow communication with the housing interior 53 and the exterior 18 of the cells 12 (FIG. 4). The sensor 14 could also be spaced from the housing 50 as long as it is in air flow communication with the housing interior 53, such as via a portal or other airway (not shown) communicating into the housing interior 53. Operation of the sensor 14 may be as above-described. The signal 25 from the sensor 14 may be utilized for an actuatable response(s) 30 as above described either within and/or external to the housing 25.

There may be some situations where it is necessary to focus on respective cells 12 out of a bank thereof, such as in one or more of the housings 50. To that end, multiple sensors 14 may be positioned in air flow communication with several cells 12. With reference to FIG. 6, a first sensor 14a may be positioned in air flow communication with a first set 12a of cells 12, and a second sensor 14b may be positioned in air flow communication with a second set 12b of cells 12. Each sensor 14a or 14b is used to monitor the respective cells 12a or 12b with which it is in air flow communication, with the signal 25 from the respective sensors 14a and 14b independently being utilized to sense which of the cells 12a or 12b are releasing the combustible vapors 25 so that the appropriate response 30 may be actuated as above described. The response 30 may be for all of the cells 12, but could just be for the respective set 12a or 12b of the cells 12 which generated the signal 25. The sensors 14a and 14b could also be in air flow communication with all of the cells 12, but in weighted manner such that sensor 14a is more responsive to vapors 22 from cells 12a and sensor 14b is more responsive to vapors 22 from cells 12b by which to provide the desired levels of signal 25 for respective responses 32 to be actuated as necessary.

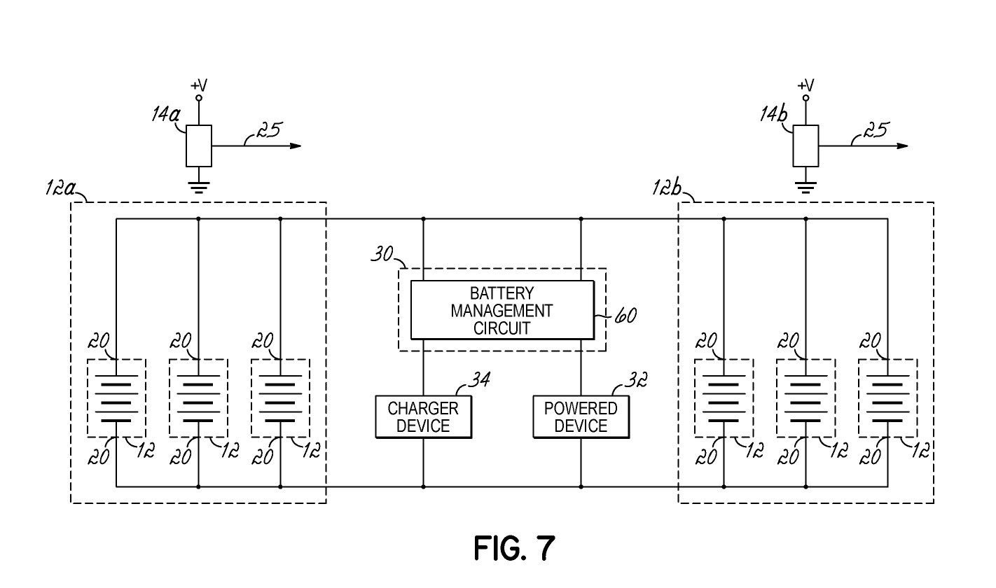

In that regard, and with reference to FIG. 7, in addition or alternative to the response(s) 30 described above, the corrective action circuit 36 may include a battery management circuit 60 which can selectively disrupt current (either by opening the electrical connection with or limiting the current through) through selected cells 12a or 12b, thus allowing the other cells 12 which are not emitting the combustible vapors 22 to continue operation as before. This approach may prove particularly beneficial where large numbers of cells 12 and safety are most of concern, such as with transportation systems.

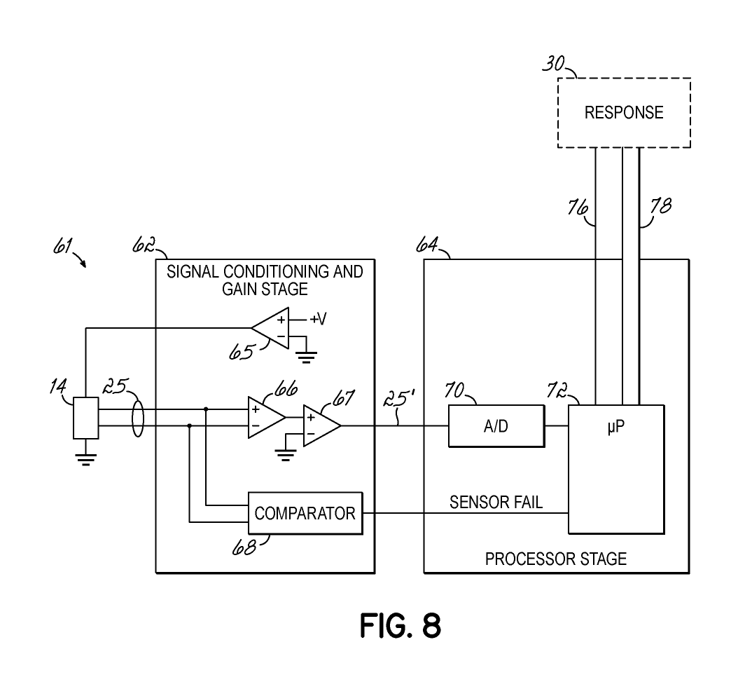

With further reference to FIG. 8, there is shown an exemplary control circuit 61 for an exemplary vapor combustion sensor 14 in the form of a NAP-78A Sensor from Nemoto Sensor Engineering Co., Ltd. Control circuit 60 includes a signal conditioning and gain stage 62 operatively coupled to provide power to and obtain the signal 25 from the sensor 14, and a processor stage 64 operatively coupled to the stage 62 to provide a conditioned signal 66 for the response 32 correlated to the signal 25. To that end, the stage 62 includes an operational amplifier 65 the inputs of which are coupled to a source of power and ground (such as from a power supply, not shown), to thus provide power to one input of the sensor 14, the other input of which is coupled to ground. The sensor 14 shown here includes two outputs collectively defining the signal 25. The outputs of the sensor 14 are coupled to the input of a second operational amplifier 66, the output of which is coupled to one input of a grounded input third operational amplifier 67. The operational amplifiers 66 and 67 can be seen as conditioning and amplifying the signal 25 to thus provide an amplified signal version 25′ thereof. The signal 25 is also coupled to a comparator 68 which provides a signal indicating failure of the sensor 14 under certain conditions, such as if the outputs from the sensor 14 are such as to indicate a short circuit or an open circuit condition of the sensor 14.

The amplified signal version 25′ is coupled to an A/D converter 70, which may be part of the stage 62 or part of the processor stage 64. The output of the converter 70 is a digital word corresponding to the level of the signal 25 from the sensor 14. That output is coupled to a processor 72, such as a microprocessor, microcontroller, or the like, which operates on the digital word to drive response 30. For example, the processor 72 may monitor the digital word to set or reset a flag 76 which actuates the response 30 when set and deactivates the response 30 when reset. By way of example, in the embodiment shown in FIG. 8, when combustible vapor 22 is not being detected from the cell(s) 12, signal 25 may be at 10 millivolts (“mV”). When the signal 25 reaches 20 mV, that is considered sufficient to be indicative that vapors 22 are exiting from the cell(s) 12. The digital word to the processor 72 is analyzed to see if it corresponds to less than 20 mV. In so, no flag 76 is to be set (or the flag 76 is reset) such that the response 30 is not actuated. If the digital word corresponds to 20 mV or more, the flag 76 is set to cause the response 30 to be actuated. Although 20 mV is selected as the trigger level in the embodiment shown in FIG. 8, other levels could be used depending on the configuration and nature of the cells 12 in relation to the sensor 14.

Additionally, or alternatively, the processor 72 may analyze the digital word corresponding to the level of the signal 25, such as between 10 and 20 mV, to provide data, such as on a data bus 78, to drive variable displays and/or battery management circuits 40 and/or 60 coupled to the data bus 78 such as via an I/O port or other communication device(s) (not shown). Thus, the hue of a display lamp may change, the number of lit lamps may be varied, and/or a number shown on a digital display of human-perceptible alert response 35 may correlate to the digital word thus providing more information about the level of danger presented by the cells 12. Additionally, or alternatively, current disruption by circuits 40 or 60 may be entire or partial depending upon the level of the signal 25.

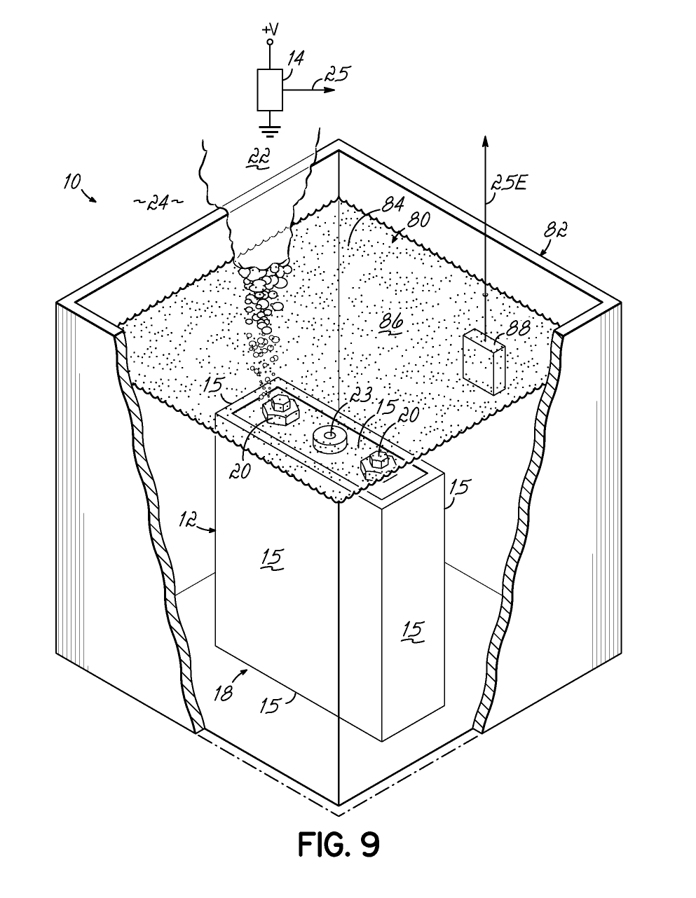

In an alternative embodiment, the cell(s) may be immersed in liquid 80 in a housing 82, as shown by FIG. 9. The liquid 80 may be a non-conductive coolant or a liquid-gas mixture, by way of example. In accordance with the principles of the present invention as described above, the chemistry 17 leaking from the cell(s) can be detected as a combustible vapor 22 once it also escapes from the liquid 80 into the air 24, such as with the combustible vapor sensor 14 in air flow communication with the surface 84 of the liquid 80 for operation as above described. Alternatively, we have determined that the chemistry 17 in the cell includes, in addition to the internal electrodes (not shown) coupled to the terminals 20, an electrolyte (typically an organic electrolyte) which, when exposed to air 24 becomes a combustible vapor 22, but which can be detected in the liquid 80 in its electrolyte form as at 86 such as by an electrolyte sensor 88 in fluid flow communication with the liquid 80, before or even without the electrolyte 86 going into the combustible vapor state. In that regard, the battery cell(s) 12 may be of a Li-Ion type that has ethylene carbonate solvent, dimethyl carbonate solvent, diethyl carbonate solvent, composite solvents, solvents of the poly(oxyethylene) family, or may be lithium cobalt oxide, lithium titanate, lithium manganese oxide, lithium iron phosphate, lithium nickel manganese cobalt oxide, and/or lithium nickel cobalt aluminum oxide, the chemistry 17 of which is expected to create a combustible vapor 22 in air 24 and/or the detectable electrolyte 86 in liquid 80.

The electrolyte sensor 88 is positioned outside of the cell(s) 12 in fluid flow communication with the exterior 18 of the hermetically sealed battery cell(s) 12, such as by being immersed in or otherwise in fluid communication with the liquid 80 as at 89. If the sensor 88 detects electrolyte 86 from the cell(s) 12, a signal 25E can be given to actuate the response 30 as previously described in relation to signal 25 from the sensor 14, by which to either generate an alert 35 and/or cause a corrective action 36 to be taken before the situation reaches the stage of overheating and/or a fire breaks out, just as in the case of the detection of combustible vapors 22.

In use, the cell(s) are provided for operation of a powered device 32, and may also be coupled to a charging device 34. A sensor 14 (and/or a sensor 88 if the cell 12 is immersed in liquid and detection of electrolyte 86 is to be undertaken) is positioned in air flow communication with the exterior 18 of the cell 12 (or in fluid flow communication therewith). The sensor 14 (or 88) generates a signal 25 (or 25E) when combustible vapors 22 are (or electrolyte 86 is) detected by the sensor. The signal 25 (or 25E) is operatively coupled to actuate the response 30 which may be a human-perceptible alert 35 and/or an automatic corrective action circuit 36 by which to provide the ability to avert or minimize the risk of overheating or fire from the cell(s) 12. In that regard, during normal operation, is predictable that a certain percentage of cells 12 will begin to fail but will do so slowly and non-catastrophically. One benefit of the present invention is not just that it can detect problems well in advance of smoke, heat or electrical failure, but that it can also grade the severity of such problems based upon predetermined levels. Thus, at some levels, it may be safe to actuate an indicator (or make a log entry), while at other levels action as acute as taking the battery off-line may be required. Indeed, with the present invention, it may be possible to detect or anticipate a catastrophic failure or fire days, weeks, or even months, before they might occur, although under severe abuse condition, the detection may occur just moments before a catastrophic failure or fire occurs. But the actuated response 32 provides an opportunity to correct the root problem before a fire occurs, for example, or to at least take evasive steps to avoid danger or harm.

By virtue of the foregoing, there is thus provided a system and method to monitor Li-Ion and similar batteries in such a way as to anticipate the potential onset of overheating or fire so that steps may be taken to avert or minimize the problem before the battery overheats or catches fire.

While the present invention has been illustrated by embodiments thereof, and while the embodiments have been described in considerable detail, they are not intended to restrict or in any way limit the scope of the appended claims to such detail. The various features shown and described herein may be used alone or in any combination. Additional advantages and modifications will readily appear to those skilled in the art. For example, while the details have been provided in the context of a Li-Ion battery having hermetically sealed cells, the invention may also be applied to other hermetically sealed battery systems in which their chemistry would produce electrolyte 86 in liquid 80 or combustible vapors 22 in air 24. Examples are lithium metal, sealed sodium, molten salt, molten sulfur, and similar sealed batteries. The invention in its broader aspects is, therefore, not limited to the specific details, representative apparatus and method and illustrative examples shown and described. Accordingly, departures may be from such details without departing from the scope of the general inventive concept.

Having described the invention, what is claimed is:

1. A method of monitoring a hermetically sealed battery cell having an exterior and an interior, the interior normally being sealed off from the exterior and containing a chemistry which, in operation, can generate combustible vapors if exposed to air should any of the chemistry exit to the exterior of the cell, the method comprising positioning a combustible vapor sensor outside of the cell in air flow communication with the exterior of the cell so as to sense combustible vapors escaping from the cell in operation thereof.

2. The method of claim 1 further comprising detecting with the sensor combustible vapors from the cell.

3. The method of claim 1 further comprising generating a signal indicative that the sensor has detected combustible vapors from the cell.

4. The method of claim 3 further comprising actuating a response based on the signal.

5. The method of claim 4, the response including being a human-perceptible alert.

6. The method of claim 5, the human-perceptible alert being selected from the group consisting of lights, displays, illuminated lettering, bells, tones, or horns, haptic indicators, and combinations thereof.

7. The method of claim 4, the response including automatic corrective action.

8. The method of claim 7, the automatic corrective action including disrupting current flow through the cell.

9. The method of claim 2 further comprising actuating a response if the sensor detects combustible vapors from the cell.

10. The method of claim 9, the response including being a human-perceptible alert.

11. The method of claim 10, the human-perceptible alert being selected from the group consisting of lights, displays, illuminated lettering, bells, tones, or horns, haptic indicators, and combinations thereof.

12. The method of claim 9, the response including automatic corrective action.

13. The method of claim 12, the automatic corrective action including disrupting current flow through the cell.

14. The method of claim 1, the cell being in a housing, the method further comprising positioning the sensor inside the housing.

15. The method of claim 1, the cell being in a housing having an opening or vent, the method further comprising positioning the sensor outside the housing in an air flow path of the opening or vent of the housing.

16. The method of claim 1, the cell being immersed in a liquid, the method further comprising positioning the sensor to be in air flow communication with a surface of the liquid.

17. The method of claim 16, the cell and liquid being in a housing, the method further composing positioning the sensor inside the housing but spaced from the liquid.

18. The method of claim 16, the cell and liquid being in a housing having an opening or vent, the method further composing positioning the sensor outside the housing in an air flow path of the opening or vent of the housing.

19. The method of claim 1, the sealed battery cell being a Li-Ion battery cell.

20. A method of monitoring a hermetically sealed battery cell having an exterior and an interior and being immersed in a liquid, the interior normally being sealed off from the exterior and containing a chemistry which, in operation, can release an electrolyte into the liquid which would be a combustible vapor if exposed to air should any of the chemistry exit to the exterior of the cell, the method comprising positioning an electrolyte sensor outside of the cell in fluid flow communication with the exterior of the cell so as to sense the electrolyte escaping from the cell in operation thereof.

21. The method of claim 20 further comprising positioning the electrolyte sensor so as to be in fluid communication with the liquid.

22. The method of claim 21 further comprising positioning the electrolyte sensor so as to be immersed in the liquid.

23. The method of claim 20, the sealed battery cell being a Li-Ion battery cell.

24. An hermetically sealed battery monitoring system comprising:
a hermetically sealed battery cell having an exterior and an interior, the interior normally being sealed off from the exterior and containing a chemistry which, in operation, can generate combustible vapors if exposed to air should any of the chemistry exit to the exterior of the cell; and
a combustible vapor sensor positioned outside of the cell in air flow communication with the exterior of the cell whereby to sense combustible vapors escaping from the cell in operation thereof.

25. The hermetically sealed battery monitoring system of claim 24, the sensor adapted to generate a signal indicative that the sensor has detected combustible vapors from the cell.

26. The hermetically sealed battery monitoring system of claim 25, an actuatable response being operatively coupled to the signal whereby to be actuated if the sensor has detected combustible vapors from the cell.

27. The hermetically sealed battery monitoring system of claim 26, the actuatable response including human-perceptible alert.

28. The hermetically sealed battery monitoring system of claim 27, the human-perceptible alert being selected from the group consisting of lights, displays, illuminated lettering, bells, tones, or horns, haptic indicators, and combinations thereof.

29. The hermetically sealed battery monitoring system of claim 26, the actuatable response including automatic corrective action circuitry.

30. The hermetically sealed battery monitoring system of claim 29, the automatic corrective action circuitry adapted to disrupt current through the cell.

31. The hermetically sealed battery monitoring system of claim 24 further comprising a housing, the cell being in the housing, the sensor being inside the housing.

32. The hermetically sealed battery monitoring system of claim 24 further comprising a housing having an opening or vent, the cell being in the housing, the sensor being outside the housing in an air flow path of the opening or vent of the housing.

33. The hermetically sealed battery monitoring system of claim 24 further comprising liquid, the cell being immersed in the liquid, the sensor being in air flow communication with a surface of the liquid.

34. The hermetically sealed battery monitoring system of claim 33 further comprising a housing, the cell and liquid being in the housing, the sensor being inside the housing but spaced from the liquid.

35. The hermetically sealed battery monitoring system of claim 33 further comprising a housing having an opening or vent, the cell and liquid being in the housing, the sensor being outside the housing in an air flow path of the opening or vent of the housing.

36. The hermetically sealed battery monitoring system of claim 24, the sealed battery cell being a Li-Ion battery cell.

37. An hermetically sealed battery monitoring system comprising:
a hermetically sealed battery cell immersed in liquid, the cell having an exterior and an interior, the interior normally being sealed off from the exterior and containing a chemistry which, in operation, can release an electrolyte into the liquid which would be a combustible vapor if exposed to air should any of the chemistry exit to the exterior of the cell; and
an electrolyte sensor positioned outside of the cell in fluid flow communication with the exterior of the cell whereby to sense the electrolyte escaping from the cell in operation thereof.

38. The hermetically sealed battery monitoring system claim 37, the electrolyte sensor being in fluid communication with the liquid.

39. The hermetically sealed battery monitoring system claim 37, the electrolyte sensor being immersed in the liquid.

40. The hermetically sealed battery monitoring system claim 37, the sealed battery cell being a Li-Ion battery cell.

41. A method of monitoring a hermetically sealed Li-Ion battery cell having internal chemistry comprising positioning a sensor outside of the cell in flow communication therewith so as to sense chemistry escaping from the cell.

42. A Li-Ion battery monitor system comprising a hermetically sealed Li-Ion battery cell having internal chemistry and a sensor outside of the cell in flow communication therewith so as to sense chemistry escaping from the cell.
